(19) United States
(12) Patent Application Publication
(10) Pub. No.: US 2025/0384797 A1
(43) Pub. Date: Dec. 18, 2025

(54) FIDELITY OF COCKPIT COLORS WITH AUTOMATIC COLOR CALIBRATION

(71) Applicant: Loft Dynamics AG., Dübendorf (CH)

(72) Inventors: Simon Kassian Locher, Dübendorf (CH); Christian Marty, Dübendorf (CH)

(21) Appl. No.: 18/745,526

(22) Filed: Jun. 17, 2024

(51) Int. Cl. G09G 3/00; G09B 9/30; H04N 9/31

(52) U.S. Cl. CPC G09G 3/001; G09B 9/307; H04N 9/317; H04N 9/3194; G09G 2320/0242; G09G 2320/0666; G09G 2320/0693; G09G 2354/00

(57) ABSTRACT

A system and method for color calibration in a visual simulation includes a simulator having a projection device. A simulation computer provides a simulated image to the projection device. The projection device converts the simulated image to a projected image, and displays the projected image to a user. At least one sensor receives the projected image displayed to the user. A calibration controller calibrates a color of the simulated image based on the sensed projected image while the projected image is displayed to the user.

### FIELD OF THE DISCLOSURE

The present disclosure relates to flight simulation systems. The disclosure has particular utility in flight simulation systems having colorized displays and the fidelity of colors on these displays, and the automatic color calibration thereof, and will be described in connection with such utility, although other utilities are contemplated.

### BACKGROUND AND SUMMARY

This section provides background information related to the present disclosure which is not necessarily prior art. This section provides a general summary of the disclosure and is not a comprehensive disclosure of its full scope or all its features.

Flight simulation is used to artificially generate aircraft flight and an environment in which the aircraft flies, for pilot training, design, or other purposes. Flight simulators typically virtually recreate situations of aircraft flight, including how aircraft react to applications of flight controls, the effects of other aircraft systems, and how the aircraft reacts to external factors such as air density, turbulence, wind shear, cloud, precipitation, etc. Non-visual simulations are also typically included, such as tactile feedback and interactions, e.g., turbulence or cross-winds, as well as auditory replications of flight events, e.g., engine noise or auditory alarms. Flight simulation is used for a variety of reasons, including flight training pilots, the design and development of the aircraft itself, and research into aircraft characteristics and control handling qualities. Some simulations are based on previously recorded flights which are virtually recreated for a pilot.

An important aspect of flight simulations is accurately replicating the simulated environment to appear and feel as close as possible to a real environment, such that personnel using the simulator can have an experience which replicates even minor details which are present in non-simulated environments. To achieve this goal, simulators often use high quality visual displays which depict high-definition images of a simulated environment, responsive and accurate tactile systems, and auditory systems which closely match the experience of a non-simulated flight. While these efforts to provide an accurate simulation improve the user experience of the simulator, which provides better training to the user, the need to accurately simulate the flight is also often required to achieve certification of a simulator from flight regulators.

One particular requirement of aviation flight simulators for pilot training is the ability to faithfully recreate the exact colors present in a real aircraft cockpit. This accurate recreation is typically required for advanced certification from aviation regulators. When virtual reality (VR) is used in a flight simulator, the projected colors from the headset display device may noticeably differ from the desired colors in the simulation model. These differences may be caused by various factors, such as the temperature of the light emitting diodes (LEDs) in the display device, age of the display device, and imperfections of various lenses and other components in the display device, among others.

Periodic calibration in between simulation exercises can be used to correct the differences between the simulated image and the projected image, but these calibrations can be tedious and inefficient. Calibrating a simulator entails stopping all simulation exercises and attaching the simulator to a calibration device. As such, these calibrations can be used from time to time, but they do not provide calibrations dynamically during use.

To provide improvements with color calibration of simulators, the present disclosure is directed to systems and methods which provide color calibration of a simulation display while it is in use, such as during a simulation exercise. In one example, a headset display device is color calibrated while the headset is being worn and used. The color calibration may use sensors mounted on or near the headset, and perform calibration based on differences in chromaticity and luminance between the expected image and the projected image actually visible to the user, with calibration prompted by measured properties of the headset.

In one embodiment, a system for color calibration in a visual simulation system includes a simulator having a projection device. A simulation computer provides a simulated image to the projection device. The projection device converts the simulated image to a projected image, and displays the projected image to a user. At least one sensor receives the projected image displayed to the user. A calibration controller calibrates a color of the simulated image based on the sensed projected image while the projected image is displayed to the user.

In one aspect, the visual simulation system is a flight simulation system.

In another aspect of the system, the projection device is within a headset.

In this aspect, the at least one sensor is positioned on a mounting structure, wherein the mounting structure is separate from the headset.

In yet another aspect, the projection device further comprises a display and a calibrated lens.

In another aspect, the calibration controller calibrates the color of the simulated image in response to at least one measured property of projection device. The at least one measured property may include one or more of: a temperature of the projection device; a duration of time of use of the projection device; a state of the simulated image; a sequence of images within the simulated image; and a change in color of the simulated image over a period of time.

In yet another aspect, a light transmission device is used to provide the projected image to the at least one sensor. The light transmission device may be at least one of: a mirror; a lens; and a fiberscope.

In another aspect, the calibration controller calibrates the color of the simulated image based on a comparison between the sensed projected image and the simulated image, where a correction profile is provided to the simulation computer when a deviation between the sensed projected image and the simulated image is detected.

In another embodiment, a method of color calibration in a visual simulation system is provided. In this method, a simulated image is provided to a projection device of a simulator. The simulated image is converted into a projected image, and the projected image is displayed to a user. The projected image is also displayed to at least one sensor while displaying the projected image to the user. The color of the simulated image is calibrated based on the sensed projected image while the projected image is displayed to the user.

In one aspect of the method, the visual simulation system is a flight simulation system.

In another aspect, the projection device is positioned within a headset which is wearable by the user.

In this aspect, the at least one sensor is positioned on a mounting structure which is separate from the headset.

In another aspect, the projected image is displayed to at least one sensor in response to a calibration command from a calibration controller.

In this aspect, a calibration command is initiated in response to at least one measured property of the projection device, wherein the at least one measured property comprises at least one of: a temperature of the projection device; a duration of time of use of the projection device; a state of the simulated image; a sequence of images within the simulated image; and a change in color of the simulated image over a period of time.

In yet another aspect, the projected image is provided to the at least one sensor with a light transmission device. The light transmission device may be at least one of: a mirror; a lens; and a fiberscope.

In another aspect, the method may include calibrating the color of the simulated image based on a comparison between the sensed projected image and the simulated image, and providing a correction profile to the simulation computer when a deviation between the sensed projected image and the simulated image is detected.

In this aspect, calibrating the color of the simulated image and creating the correction profile may include: providing a calibration command; defining a set of at least one test image and at least one validation image; disabling an existing correction profile; displaying the at least one test image; measuring the projected image; applying at least one correction profile based on a detected error; verifying the at least one correction profile with the at least one validation image; and enabling a new correction profile.

In another embodiment, a method of color calibration of a headset display in a flight simulator is provided. Here, a simulated image of a cockpit is provided to a projection device of the headset display of the flight simulator. The simulated image is converted into a projected image by the projection device of the headset display. The projected image is displayed to a user wearing the headset display. The projected image is displayed to at least one sensor while displaying the projected image to the user. A color of the simulated image is calibrated based on the sensed projected image while the projected image is displayed to the user.

In one aspect, the method may further include calibrating the color of the simulated image in response to at least one measured property of projection device. The at least one measured property may be at least one of: a temperature of the projection device; a duration of time of use of the projection device; a state of the simulated image; a sequence of images within the simulated image; and a change in color of the simulated image over a period of time.

In another aspect, calibrating the color of the simulated image and creating a correction profile may include: providing a calibration command; defining a set of at least one test image and at least one validation image; disabling an existing correction profile; displaying the at least one test image; measuring the projected image; applying at least one correction profile based on a detected error; verifying the at least one correction profile with the at least one validation image; and enabling a new correction profile.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the disclosure will be seen in the following detailed description, taken in conjunction with the accompanying drawings. The drawings described herein are for illustrative purposes only of selected embodiments and not all possible implementations and are not intended to limit the scope of the present disclosure.

In the drawings:

FIG. 1 is a diagrammatic illustration of a system for color calibration in a visual simulation system, in accordance with the present disclosure;

FIG. 2 is a flowchart illustrating a method of color calibration in a visual simulation system, in accordance with the present disclosure;

FIG. 3 is a flowchart illustrating a method of color calibration of a headset display in a flight simulator, in accordance with the present disclosure; and

FIG. 4 is a flowchart illustrating a method of calibrating color of a simulated image and creating a correction profile, in accordance with the present disclosure.

### DETAILED DESCRIPTION

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components, and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers, and/or sections, these elements, components, regions, layers, and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

To provide improvements with color calibration of simulators, the present disclosure is directed to systems and methods which provide color calibration of a simulation display while it is in use, such as during a simulation exercise. In one example, a headset display device is color calibrated while the headset is being worn and used. The color calibration may use sensors mounted on or near the headset, and perform calibration based on differences in chromaticity and luminance between the expected image and the projected image actually visible to the user, with calibration prompted by measured properties of the headset.

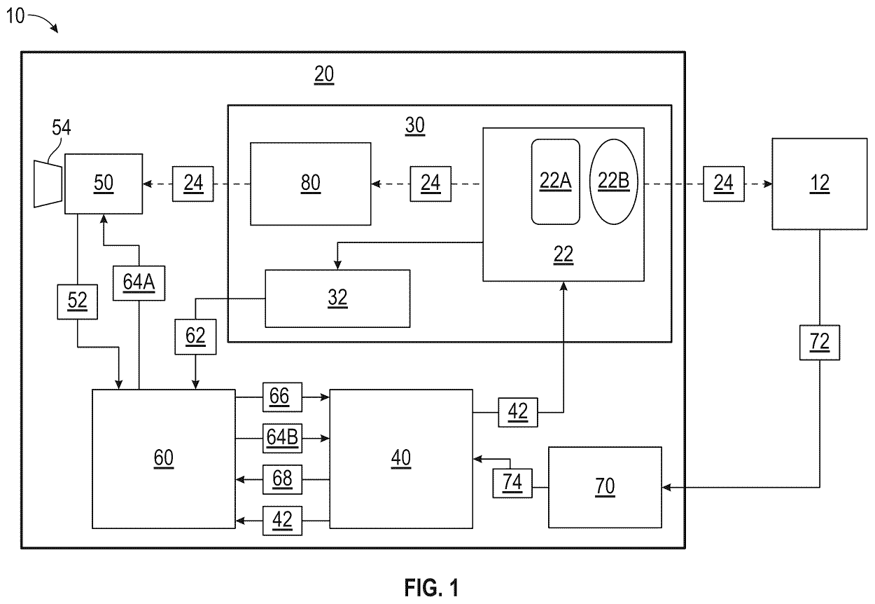

FIG. 1 is a diagrammatic illustration of a system for color calibration in a visual simulation system 10, in accordance with the present disclosure. As shown in FIG. 1, the system for color calibration in a visual simulation system 10, which may be referred to herein as ‘system 10’ includes a simulator 20 which is used to provide a simulated environment to user 12. Simulator 20 may be capable of providing visual simulations for various situations and settings but may have particular utility as a flight simulation system used in aviation flight training or other aviation related uses. The simulator 20 may include features and devices based on the intended use, including, for instance, tactile features, visual displays, auditory systems, or other devices which replicate a particular non-simulated environment.

In the example of FIG. 1, simulator 20 has at least one projection device 22 which is embodied in a headset 30. The headset 30 may be a head-worn unit which is placed on the head of user 12 during a simulation exercise, while projection device 22 may be a visual display device in headset 30 that the user can see when he or she places headset 30 on his or her head. In other examples, projection device 22 may be a non-head-mounted device, such as an array of display screens which are positioned within a simulator room. Generally, projection device 22 may be situated such that it is visible to user 12 along a large portion of the field of view of user 12, or to the entirety of user's 12 field of view.

In general architecture and operation, a simulation computer 40 is within or in communication with the simulator 20 and provides simulation data to projection device 22. In particular, simulation computer 40 may provide a simulated image 42 to projection device 22, where projection device 22 converts the simulated image 42 to a projected image 24 which is displayed to user 12. Projected image 24 is also provided to at least one sensor 50, such that sensor 50 receives the same projected image 24 which is displayed to user 12. Sensor 50 determines light properties of projected image 24, and is in communication with a calibration controller 60. Calibration controller 60 is in communication with simulation computer 40, and it calibrates a color of simulated image 42 based on the sensed projected image 24. This sensing by sensor 50 and calibration by calibration controller 60 occurs while projected image 24 is displayed to user 12, such that corrections or calibrations to projected image 24 can occur simultaneously with use of the simulator 20 and without interrupting a simulation exercise.

In greater detail, simulation computer 40 generates the simulated images 42 based on a simulation of a flying aircraft and its surroundings to be shown to user 12 who is manipulating simulator 20. These simulation images 42 are the expected images that the user 12 would expect to see in a non-simulated environment, e.g., in a real setting. Simulated images 42 are communicated or otherwise directed to headset 30 which has projection device 22 therein, mounted in a location in the field of view of user 12 when user 12 is wearing headset 30. In one example, projection device 22 may be a display device which comprises a display screen 22A, such as an organic light-emitting diode (OLED) display, and one or more calibrated lenses 22B to give user 12 appropriate depth perception. The projection device 22 converts simulated images 42 into projected images 24 which are visible to user 12. Based on, or in response to, these projected images 24, user 12 makes control inputs 72 using flight controls 70, which generate control signals 74 for simulation computer 40. These control signals 74 are interpreted by simulation computer 40 as inputs to the simulated flying aircraft over the course of the simulation, such that simulation computer 40 can generate new simulated images 42. This process repeats continuously, or near continuously, during the simulation exercise.

Calibration of the simulator 20 may occur at any time. In one example, calibration may be prompted by measurements of properties of projection device 22 and other aspects of headset 30. These measured properties may be any form of data which is sensed or taken by one or more measurement devices 32. The measured property may include various information which can be used to indicate the need for calibration. In one example, the measured property may include one or more of a temperature of projection device 22 or headset 30, or a duration of time of use of projection device 22 or headset 30, or a state of simulated image 42, or a sequence of images within simulated image 42, or a change in color of simulated image 42 over a period of time.

Measurement data from one or more of these measured properties may be provided to calibration controller 60 via signal 62, which then analyzes the need to initiate a calibration command 64A to sensor 50 and a calibration command 64B to simulation computer 40. For example, calibration controller 60 may decide to send the calibration commands 64A, 64B, in part, based on when the temperature of projection device 22 exceeds a predetermined temperature, as measured by a digital thermometer or similar measurement device 32. In another example, calibration controller 60 decides to send the calibration commands 64A, 64B, in part, based on how much time headset 30 has been used, as measured by a timer, incorporated in headset 30 or in simulation computer 40.

Calibration may also be initiated by a state or characteristic of the simulated images 42. For example, calibration controller 60 decides to send the calibration commands 64A, 64B depending, in part, on the simulated flight state. For instance, if the simulated state of the flight is nominal, calibration commands 64A, 64B may be sent, whereas if the simulated state of the flight is not nominal, calibration commands 64A, 64B may be delayed or deferred. In yet another example, calibration controller 60 decides to send the calibration commands 64A, 64B depending, in part, on a recent sequence of simulated images 42 provided to projection device 22 and displayed as projected images 24. In this example, if the average color of simulated images 42 has not changed significantly over a time duration, a calibration command 64A, 64B may be sent. Other factors may also be used to initiate a calibration command 64A, 64B.

When prompted by a calibration command 64A, 64B, the projected image 24 shown to the user 12 may be captured by a light transmission device 80, which may be, for instance, a mirror, a lens, a fiberscope, or another light transmitting device. Light transmission device 80 can be mounted on or within headset 30 and directs projected image 24 to sensor 50. In one example, light transmission device 80 is a combination of mirrors and lenses, which focus and transmit the projected image 24 to sensor 50 mounted on the headset 30. In another example, light transmission device 80 includes a fiberscope, which transmits projected image 24 from headset 30 to sensor 50 not mounted on headset 30 and instead mounted elsewhere on the simulator 20. In either example, light transmission device 80 may provide the projected image 24 to sensor 50 exactly as it appears to user 12, or with minimal differences, such that sensor 50 receives an accurate copy or representation of the projected image 24.

Sensor 50 may be any type of sensing device which is useful for color calibration, such as a display color analyzer (DCA) or colorimeter, or another device, which takes light measurements of projected image 24. These light measurements may include, but are not limited to, chromaticity and luminance of part or all of projected image 24. It is noted that sensor 50 may be positioned on a mounting structure 54 which is separate from headset 30 itself, such that sensor 50 is not mechanically attached or integrated into headset 30. The use of the separated mounting structure 54 to hold sensor 50 in a location near but not on the headset 30 may allow for the use of larger and more accurate sensors than conventionally used, such as colorimeters, without encumbering the user 12.

Upon sensing the projected image 24, the light measurements may be provided from sensor 50 to calibration controller 60 via light measurement signal 52. Calibration controller 60 may perform a comparison between the representative data in the light measurement signal 52 and the simulated image 42, which is provided to calibration controller 60 by simulation computer 40. Calibration controller 60 may also receive a simulated state signal 68 from simulation computer 40 which indicates a state of the simulated image 42, which may be used to determine the need for calibration.

Results of the comparison may be used to indicate a need for calibration. For instance, detection of a deviation between light measurements of projected image 24 sensed by sensor 50 and the simulated image 42 can indicate the need for color calibration or recalibration. Upon detection of a need for color calibration, calibration controller 60 sends a correction profile 66 to simulation computer 40. The correction profile 66 changes the color value or values of the simulated image 42, in part or in all of the simulated image 42, and for some or all of the simulated images 42 generated by simulation computer 40 subsequently, as needed to calibrate colors in the simulated image 42, so that the projected image 24 is accurately provided to user 12.

The system 10 described herein can help provide visual simulation systems with accurately projected colors which are necessary for the certification of a display device for pilot training. Moreover, the system 10 allows for calibration with minimal interference to the user 12, to the simulation system itself, to a simulation schedule, and other aspects of the simulation. Color calibration of the projection device 22 while it is in use ensures color accuracy while a pilot or other user of the simulator 20 is in the simulation. As such, it avoids the necessity of a pilot needing to run through dedicated calibration steps during use. Calibration prompted by other measurements of the headset, such as temperature or operational time, saves time and energy by running calibration only when necessary and without delaying use of the simulator 20.

The system 10 provides an improvement over conventional color calibration devices and techniques. Conventional solutions for color calibration of headset display devices do not calibrate based on a projected image while the headset is in use. Some solutions calibrate based on the emitted light, not the projected image itself. Additionally, some solutions require the device to be placed on a dedicated calibration rig to see the projected image. While some solutions use other properties of the headset to determine the emittance of display elements, no conventional system uses other properties to prompt calibration while the headset is in use. In the system 10, in one example, simulated image 42 may be generated by simulation computer 40 and provided to calibration controller 60 when a calibration command 64B that is sent relates to a specific set of calibration images. It is possible for these images to be projected so quickly that user 12 cannot notice them during the simulation. In another example, the simulated image 42 generated when a calibration command 64A is sent is the same simulated image 42 of the simulated flight that would have been generated and provided to user 12 if a calibration command 64A was not sent.

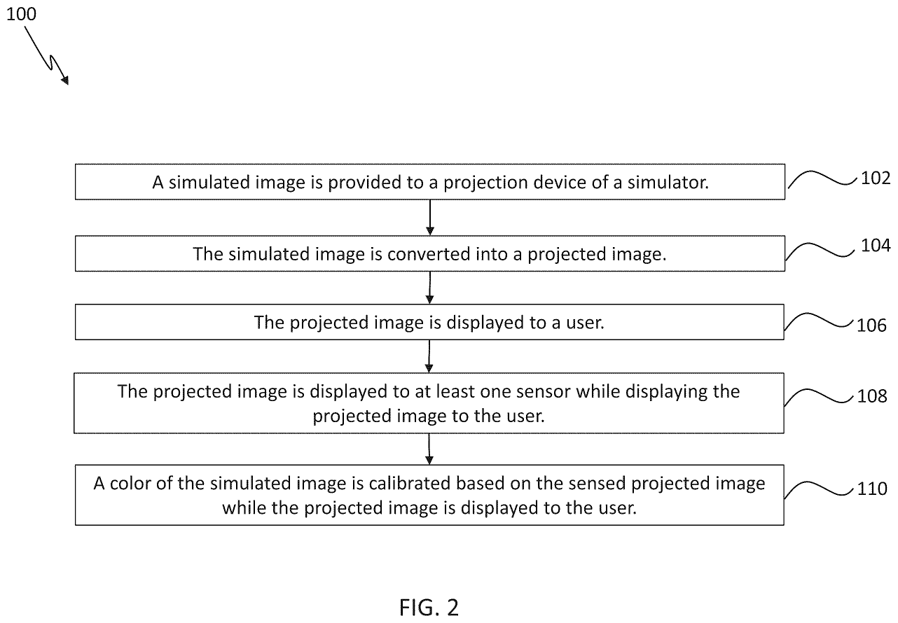

FIG. 2 is a flowchart 100 illustrating a method of color calibration in a visual simulation system, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a simulated image is provided to a projection device of a simulator. The simulated image is converted into a projected image (block 104). The projected image is displayed to a user (block 106). The projected image is displayed to at least one sensor while displaying the projected image to the user (block 108). A color of the simulated image is calibrated based on the sensed projected image while the projected image is displayed to the user (block 110).

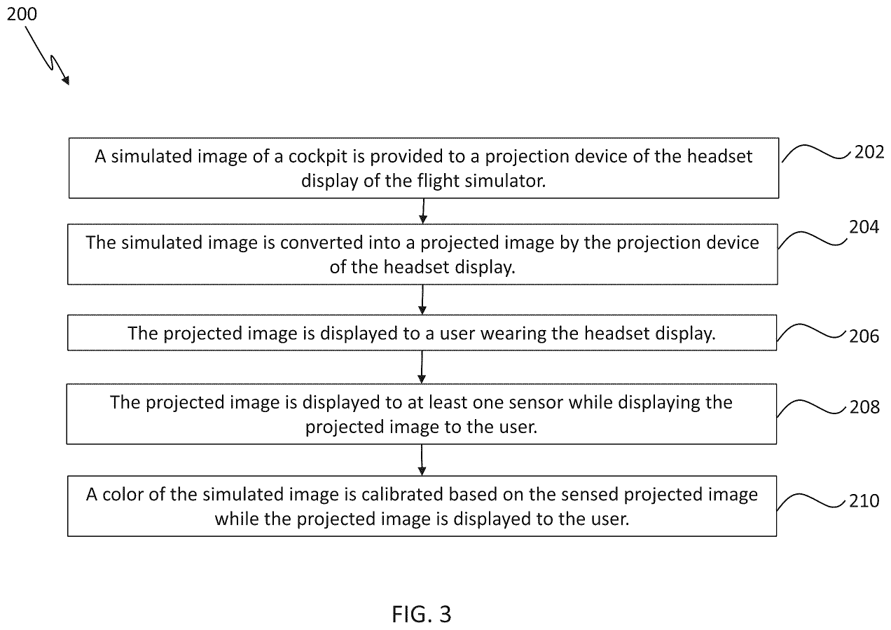

FIG. 3 is a flowchart 200 illustrating a method of color calibration of a headset display in a flight simulator, in accordance with the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a simulated image of a cockpit is provided to a projection device of the headset display of the flight simulator. The simulated image is converted into a projected image by the projection device of the headset display (block 204). The projected image is displayed to a user wearing the headset display (block 206). The projected image is displayed to at least one sensor while displaying the projected image to the user (block 208). A color of the simulated image is calibrated based on the sensed projected image while the projected image is displayed to the user (block 210).

Any number of additional steps, functions, processes, or variants thereof may be included in the methods of FIGS. 2-3, including any disclosed relative to any other figure of this disclosure. For instance, these methods may further include calibrating the color of the simulated image based on a comparison between the sensed projected image and the simulated image, and providing a correction profile to the simulation computer when a deviation between the sensed projected image and the simulated image is detected.

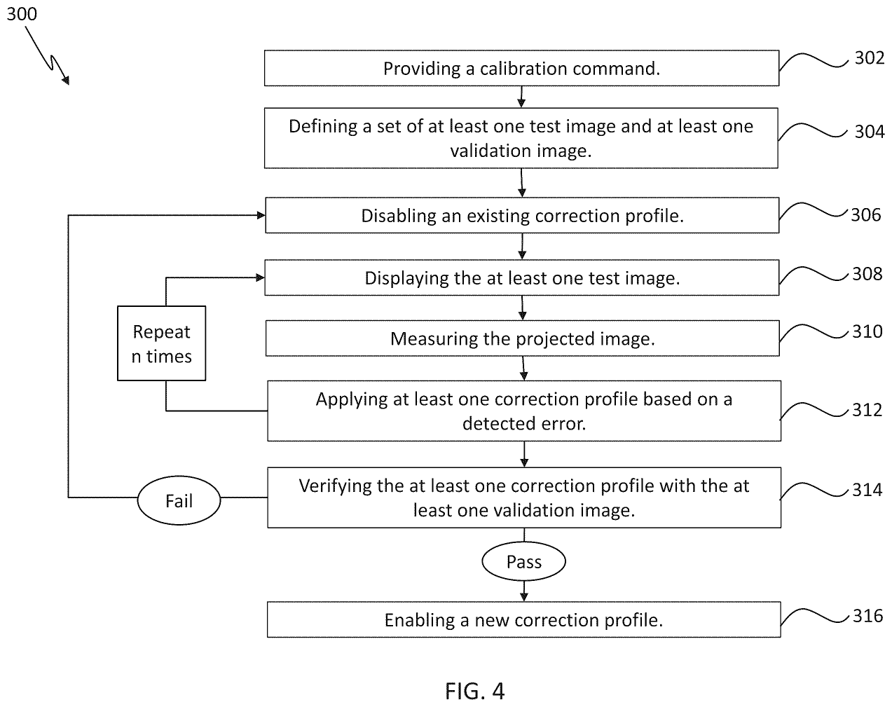

Additionally, FIG. 4 is a flowchart 300 illustrating a method of calibrating color of a simulated image and creating a correction profile, in accordance with the present disclosure, which may be used with the methods of FIGS. 2-3. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

In general, calibrating the color of the simulated image and creating the correction profile may include, in one example: providing a calibration command (block 302), defining a set of at least one test image and at least one validation image (block 304), disabling an existing correction profile (306), displaying the at least one test image (block 308), measuring the projected image (block 310), applying at least one correction profile based on a detected error (block 312), verifying the at least one correction profile with the at least one validation image (block 314), and enabling a new correction profile (block 316).

In greater detail of FIG. 4, when a calibration command is provided, the simulation computer may define a series of test and validation images to be the next few simulated images which are expected. The simulation computer then disables the existing correction profile and displays the test images as the simulated images. The sensor measures the projected images generated based on the simulated images, and a temporary correction profile is calculated and applied by the calibration controller. This process may be repeated a number of n times, which could be a fixed number of times or be dependent on a particular situation. For example, the number of times the process is repeated may be based on the error between the simulated and projected images as calculated by the calibration controller.

A finalized correction profile created after repetition may then be verified through a validation process, whereby the validation images are projected with the finalized correction profile. If the error between the validation images and the projected images passes or satisfies a predefined criteria, for example, being lower than a certain threshold, as measured by the calibration controller, the finalized correction profile is enabled for the simulation computer. Otherwise, if the error between the validation images and the projected images fails, the finalized correction profile is disabled and the process of generating profiles may be repeated.

It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

### LIST OF REFERENCES

10 system
12 user
20 simulator
22 projection device
22A display screen
22B calibrated lenses
24 projected image
30 headset
32 measurement devices
40 simulation computer
42 simulated image
50 sensor
52 light measurement signal
54 mounting structure
60 calibration controller
62 signals
64A calibration commands
64B calibration commands
66 correction profile
68 simulated state signal
70 flight controls
72 control inputs
74 control signals
80 light transmission device
100-110 Flow chart and steps
200-210 Flow chart and steps
300-316 Flow chart and steps

What is claimed is:

1. A system for color calibration in a visual simulation system comprising:
a simulator having a projection device;
a simulation computer providing a simulated image to the projection device, wherein the projection device converts the simulated image to a projected image, and displays the projected image to a user;
at least one sensor receiving a projected image displayed to the user; and
a calibration controller, wherein the calibration controller calibrates a color of the simulated image based on the sensed projected image while the projected image is displayed to the user.

2. The system of claim 1, wherein the visual simulation system further comprises a flight simulation system.

3. The system of claim 1, wherein the projection device is within a headset.

4. The system of claim 3, wherein the at least one sensor is positioned on a mounting structure, wherein the mounting structure is separate from the headset.

5. The system of claim 1, wherein the projection device further comprises a display and a calibrated lens.

6. The system of claim 1, wherein the calibration controller calibrates the color of the simulated image in response to at least one measured property of projection device, wherein the at least one measured property comprises at least one of: a temperature of the projection device; a duration of time of use of the projection device; a state of the simulated image; a sequence of images within the simulated image; and a change in color of the simulated image over a period of time.

7. The system of claim 1, further comprising a light transmission device providing the projected image to the at least one sensor, wherein the light transmission device further comprises at least one of: a mirror; a lens; and a fiberscope.

8. The system of claim 1, wherein the calibration controller calibrates the color of the simulated image based on a comparison between the sensed projected image and the simulated image, wherein a correction profile is provided to the simulation computer when a deviation between the sensed projected image and the simulated image is detected.

9. A method of color calibration in a visual simulation system, the method comprising:
providing a simulated image to a projection device of a simulator;
converting the simulated image into a projected image;
displaying the projected image to a user;
displaying the projected image to at least one sensor while displaying the projected image to the user; and
calibrating a color of the simulated image based on the sensed projected image while the projected image is displayed to the user.

10. The method of claim 9, wherein the visual simulation system further comprises a flight simulation system.

11. The method of claim 9, further comprising positioning the projection device within a headset wearable by the user.

12. The method of claim 11, further comprising positioning the at least one sensor on a mounting structure which is separate from the headset.

13. The method of claim 9, further comprising displaying the projected image to at least one sensor in response to a calibration command from a calibration controller.

14. The method of claim 13, further comprising initiating a calibration command in response to at least one measured property of the projection device, wherein the at least one measured property comprises at least one of: a temperature of the projection device; a duration of time of use of the projection device; a state of the simulated image; a sequence of images within the simulated image; and a change in color of the simulated image over a period of time.

15. The method of claim 9, further comprising providing the projected image to the at least one sensor with a light transmission device, wherein the light transmission device further comprises at least one of: a mirror; a lens; and a fiberscope.

16. The method of claim 9, further comprising:
calibrating the color of the simulated image based on a comparison between the sensed projected image and the simulated image; and
providing a correction profile to the simulation computer when a deviation between the sensed projected image and the simulated image is detected.

17. The method of claim 16, wherein calibrating the color of the simulated image and creating the correction profile further comprises:
providing a calibration command;
defining a set of at least one test image and at least one validation image;
disabling an existing correction profile;
displaying the at least one test image;
measuring the projected image;
applying at least one correction profile based on a detected error;
verifying the at least one correction profile with the at least one validation image; and
enabling a new correction profile.

18. A method of color calibration of a headset display in a flight simulator, the method comprising:
providing a simulated image of a cockpit to a projection device of the headset display of the flight simulator;
converting, by the projection device of the headset display, the simulated image into a projected image;
displaying the projected image to a user wearing the headset display;
displaying the projected image to at least one sensor while displaying the projected image to the user; and
calibrating a color of the simulated image based on the sensed projected image while the projected image is displayed to the user.

19. The method of claim 18, further comprising calibrating the color of the simulated image in response to at least one measured property of projection device, wherein the at least one measured property comprises at least one of: a temperature of the projection device; a duration of time of use of the projection device; a state of the simulated image; a sequence of images within the simulated image; and a change in color of the simulated image over a period of time.

20. The method of claim 18, wherein calibrating the color of the simulated image and creating a correction profile by:
providing a calibration command;
defining a set of at least one test image and at least one validation image;
disabling an existing correction profile;
displaying the at least one test image;
measuring the projected image;
applying at least one correction profile based on a detected error;
verifying the at least one correction profile with the at least one validation image: and enabling a new correction profile.
